(19) United States
(12) Patent Application Publication
(10) Pub. No.: US 2024/0244108 A1
(43) Pub. Date: Jul. 18, 2024

(54) ON-BOARD APPARATUS, ON-BOARD COMMUNICATION SYSTEM, AND DATA TRANSMISSION METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Masahiro ENDO, Yokkaichi-shi, Mie (JP)

(21) Appl. No.: 18/551,108

(22) PCT Filed: Mar. 7, 2022
(86) PCT No.: PCT/JP2022/009728

§ 371 Date: Sep. 18, 2023

(30) Foreign Application Priority Data
Mar. 19, 2021 (JP) 2021-045322

(51) Int. Cl. H04L 67/12

(52) U.S. Cl. CPC H04L 67/12

(57) ABSTRACT

An on-board apparatus includes: an estimation unit configured to estimate an occurrence frequency of an event message that is transmitted in an on-board network, and a control unit configured to control transmission of update data to an apparatus targeted for update in the on-board network, based on a result of estimation performed by the estimation unit.

### CROSS-REFERENCE TO RELATED APPLICATIONS

This application is the U.S. national stage of PCT/JP2022/009728 filed on Mar. 7, 2022, which claims priority of Japanese Patent Application No. JP 2021-045322 filed on Mar. 19, 2021, the contents of which are incorporated herein.

### TECHNICAL FIELD

The present disclosure relates to an on-board apparatus, an on-board communication system, and a data transmission method.

### BACKGROUND

JP 2018-65410A discloses a technique to be described below. That is to say, JP 2018-65410A discloses a software update control apparatus that is a software update control apparatus for controlling update of software for an electronic control apparatus of a vehicle, and includes: an obtaining unit that obtains update information indicating content of the software for an electronic control apparatus to be updated, an update rank determination unit that determines an update rank indicating the degree of difficulty of update as a level, with respect to the obtained update information, based on at least one of the content, the state of the electronic control apparatus and the state of the vehicle, an update rank updating unit that updates the determined update rank, an executability rank determination unit that determines an executability rank indicating, as a level, the degree of easiness of executing update with the update information, and an update possibility determination unit that compares the updated update rank with the determined executability rank, and determines whether or not to execute update of the software for the electronic control apparatus.

There is a desire for a technique that enables further expansion of opportunities for updating an apparatus in an on-board network than the technique described in JP 2018-65410A.

The present disclosure has been made in order to solve the aforementioned issue, and an object thereof is to provide an on-board apparatus, an on-board communication system, and a data transmission method that can further expand opportunities for updating an apparatus in an on-board network.

### SUMMARY

An on-board apparatus according to the present disclosure includes: an estimation unit configured to estimate an occurrence frequency of an event message that is transmitted in an on-board network, and a control unit configured to control transmission of update data to an apparatus targeted for update in the on-board network, based on a result of estimation performed by the estimation unit.

An on-board communication system according to the present disclosure includes: an estimation unit and a control unit, the estimation unit estimates an occurrence frequency of an event message that is transmitted in an on-board network, and notifies the control unit of an estimation result, and the control unit controls transmission of update data to an apparatus targeted for update in the on-board network, based on the estimation result notified by the estimation unit.

A data transmission method according to the present disclosure is a data transmission method that is performed in an on-board communication system that includes an estimation unit and a control unit, the data transmission method including: a step of the estimation unit estimating an occurrence frequency of an event message that is transmitted in an on-board network, and notifying the control unit of an estimation result, and a step of the control unit controlling transmission of update data to an apparatus targeted for update in the on-board network, based on the estimation result notified by the estimation unit.

An aspect of the present disclosure can be realized not only as an on-board apparatus that includes such characteristic processing units, but can also be realized as a data transmission method for executing steps of such characteristic processing, a program for causing a computer to execute such steps, or a semiconductor integrated circuit that realizes a portion or the entirety of the on-board apparatus.

### Advantageous Effects

According to the present disclosure, it is possible to further expand opportunities for updating an apparatus in an on-board network.

Techniques for expanding opportunities for updating software for an electronic control apparatus while suppressing restriction on functions of a vehicle have been developed.

### BRIEF DESCRIPTION OF DRAWINGS

FIG. 1 is a diagram showing a configuration of an update system according to an embodiment of the present disclosure.

FIG. 2 is a diagram showing a configuration of an on-board communication system according to an embodiment of the present disclosure.

FIG. 3 is a diagram showing a configuration of an integrated ECU according to an embodiment of the present disclosure.

FIG. 4 is a plan view showing an example of a travelling state of a vehicle according to an embodiment of the present disclosure.

FIG. 5 is a plan view showing another example of travelling states of vehicles according to an embodiment of the present disclosure.

FIG. 6 is a flowchart that defines an example of an operation procedure when the integrated ECU according to the embodiment of the present disclosure transmits update data.

FIG. 7 is a flowchart that defines another example of the operation procedure when the integrated ECU according to the embodiment of the present disclosure transmits update data.

FIG. 8 is a diagram showing an example of a sequence of data transmission in the on-board communication system according to the embodiment of the present disclosure.

### DETAILED DESCRIPTION OF PREFERRED EMBODIMENTS

First, content of embodiments of the present disclosure will be listed and described.

An on-board apparatus according to an embodiment of the present disclosure includes: an estimation unit configured to estimate an occurrence frequency of an event message that is transmitted in an on-board network, and a control unit configured to control transmission of update data to an apparatus targeted for update in the on-board network, based on a result of estimation performed by the estimation unit.

Due to a configuration in which the occurrence frequency of an event message in the on-board network is estimated and transmission of update data is controlled based on the estimation result as described above, update data can be transmitted at a timing when the occurrence frequency of an event message decreases, for example, and thus update data can be efficiently transmitted to the apparatus targeted for update using a limited communication band of the on-board network. Therefore, it is possible to further expand the opportunities for updating the apparatus in the on-board network.

The estimation unit may estimate the occurrence frequency based on map information and a current position of a vehicle in which the on-board apparatus is mounted.

The occurrence frequency of an event message may change in accordance with an area in which the vehicle is travelling, but, with the above configuration, update data can be transmitted at more timings when the occurrence frequency of an event message is estimated to decrease due to the vehicle travelling in a specific area.

The estimation unit may estimate the occurrence frequency based further on traffic congestion information.

With such a configuration, update data can be transmitted at a timing when the occurrence frequency of an event message decreases due to the vehicle travelling in a congested area.

The estimation unit may estimate the occurrence frequency based on a change amount of a travelling speed of a vehicle in which the on-board apparatus is mounted.

The occurrence frequency of an event message may change in accordance with a change in an external environment surrounding the vehicle, but, with the above configuration, update data can be transmitted at more timings when the occurrence frequency of an event message is estimated to decrease due to a change in the external environment caused by a change in the travelling speed of the vehicle.

The estimation unit may estimate the occurrence frequency based on a travelling speed of a vehicle in which the on-board apparatus is mounted and a relative speed between the vehicle and another vehicle.

The occurrence frequency of an event message may change in accordance with a change in the external environment surrounding the vehicle, but, with the above configuration, update data can be transmitted at more timings when the occurrence frequency of an event message is estimated to decrease due to a change in the external environment that is based on the travelling speed of the vehicle and the relative speed between the vehicle and another vehicle.

The event message may be a message that complies with SOME/IP (Scalable service-Oriented MiddlewarE over IP).

With such a configuration, for example, it is possible to estimate the occurrence frequency of an event message that complies with SOME/IP, and control transmission of update data based on the estimation result.

An on-board communication system according to an embodiment of the present disclosure includes: an estimation unit and a control unit, the estimation unit is configured to estimate an occurrence frequency of an event message that is transmitted in an on-board network, and notify the control unit of an estimation result, and the control unit is configured to control transmission of update data to an apparatus targeted for update in the on-board network, based on the estimation result notified by the estimation unit.

Due to a configuration in which the occurrence frequency of an event message in the on-board network is estimated and transmission of update data is controlled based on the estimation result as described above, update data can be transmitted at a timing when the occurrence frequency of an event message decreases, for example, and thus update data can be efficiently transmitted to the apparatus targeted for update using a communication band of the on-board network. Therefore, it is possible to further expand the opportunities for updating the apparatus in the on-board network.

A data transmission method according to an embodiment of the present disclosure is a data transmission method that is performed in an on-board communication system that includes an estimation unit and a control unit, the data transmission method including: a step of the estimation unit estimating an occurrence frequency of an event message that is transmitted in an on-board network, and notifying the control unit of an estimation result, and a step of the control unit controlling transmission of update data to an apparatus targeted for update in the on-board network, based on the estimation result notified by the estimation unit.

Due to the method for estimating the occurrence frequency of an event message in the on-board network and controlling transmission of update data based on the estimation result as described above, update data can be transmitted at a timing when the occurrence frequency of an event message decreases, for example, and thus update data can be efficiently transmitted to the apparatus targeted for update using a limited communication band of the on-board network. Therefore, it is possible to further expand the opportunities for updating the apparatus in the on-board network.

Embodiments of the present disclosure will be described below with reference to the drawings. Note that the same reference numerals are given to the same or equivalent portions in the drawings, and a description thereof is not repeated. In addition, at least some of the embodiments described below may be combined as appropriate.

### Configuration and Basic Operations

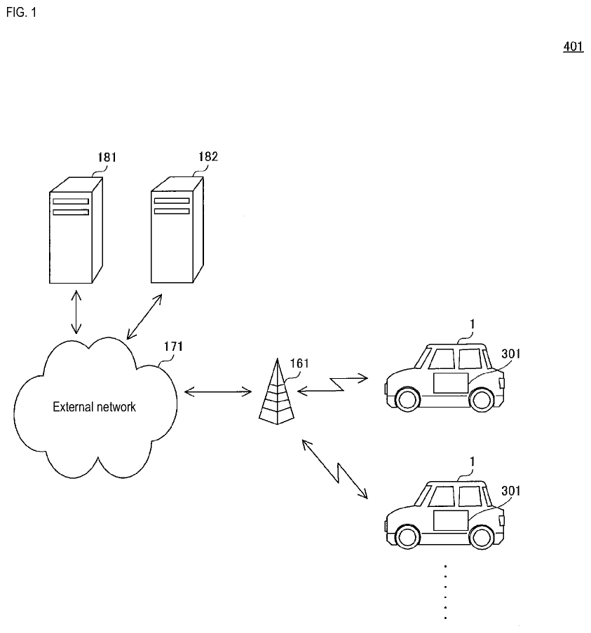

FIG. 1 is a diagram showing a configuration of an update system according to an embodiment of the present disclosure. As shown in FIG. 1, an update system 401 includes an update server 181, a traffic information server 182, and a plurality of on-board communication systems 301. Each on-board communication system 301 is mounted in a vehicle 1. The update server 181 is provided in an OTA (Over The Air) center, for example. The update server 181 periodically or non-periodically transmits update data for updating software of apparatuses in the on-board communication systems 301 to the on-board communication systems 301. The traffic information server 182 periodically or non-periodically transmits traffic congestion information to the on-board communication systems 301.

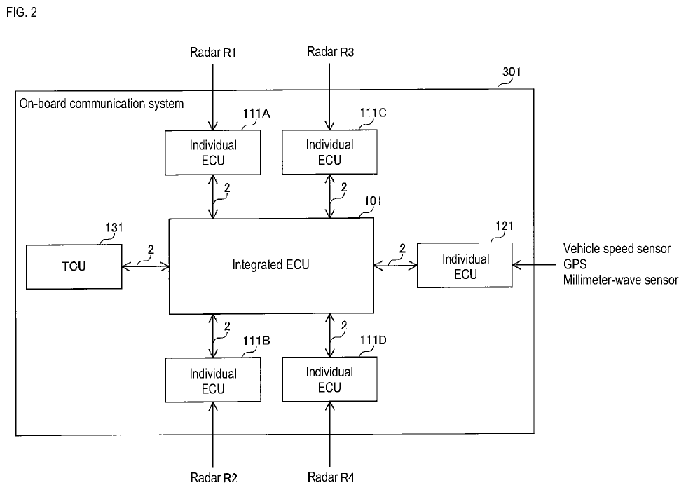

FIG. 2 is a diagram showing a configuration of an on-board communication system according to an embodiment of the present disclosure. As shown in FIG. 2, the on-board communication system 301 includes an integrated ECU 101, individual ECUs 111A, 111B, 111C, and 111D, an individual ECU 121, and a TCU 131. The integrated ECU 101 is an example of an on-board apparatus. Hereinafter, each of the individual ECUs 111A, 111B, 111C, and 111D is also referred to as an “individual ECU 111”.

The individual ECUs 111, the individual ECU 121, and the TCU 131 are connected to the integrated ECU 101 via cables 2. Each cable 2 is an Ethernet (registered trademark) cable, for example. The integrated ECU 101, the individual ECUs 111, the individual ECU 121, and the TCU 131 constitute an on-board network.

As shown in FIGS. 1 and 2, the TCU 131 can communicate with the update server 181 and the traffic information server 182 via a wireless base station apparatus 161 using an IP packet, for example.

More specifically, the TCU 131 can perform wireless communication with the wireless base station apparatus 161 in compliance with the communication standard of LTE (Long Term Evolution), 3G, or the like.

Upon receiving an IP packet P1 that includes update data from the update server 181 via an external network 171, the wireless base station apparatus 161 adds the received IP packet P1 to a wireless signal and transmits the wireless signal to the TCU 131. In addition, upon receiving an IP packet P2 that includes traffic congestion information, from the traffic information server 182 via the external network 171, the wireless base station apparatus 161 adds the received IP packet P2 to a wireless signal, and transmits the wireless signal to the TCU 131.

Upon receiving, from the wireless base station apparatus 161, the wireless signal that includes the IP packet P1 received from the update server 181, for example, the TCU 131 obtains the IP packet P1 from the received wireless signal, stores the obtained IP packet P1 to an Ethernet frame, and transmits the Ethernet frame to the integrated ECU 101. In addition, for example, upon receiving, from the wireless base station apparatus 161, the wireless signal that includes the IP packet P2 received from the traffic information server 182, the TCU 131 obtains the IP packet P2 from the received wireless signal, stores the obtained IP packet P2 to an Ethernet frame, and transmits the Ethernet frame to the integrated ECU 101.

In a predetermined cycle or in response to a request from the integrated ECU 101, the individual ECU 121 obtains the travelling speed of the vehicle 1 measured by a vehicle speed sensor mounted in the vehicle 1, and generates speed information indicating the obtained travelling speed. The individual ECU 121 then stores the generated speed information to an Ethernet frame, and transmits the Ethernet frame to the integrated ECU 101.

In addition, in a predetermined cycle or in response to a request from the integrated ECU 101, the individual ECU 121 obtains the current position of the vehicle 1 in which the individual ECU 121 is mounted, based on radiowaves from GPS (Global Positioning System) satellites, and generates position information indicating the obtained current position. The individual ECU 121 then stores the generated position information to an Ethernet frame and transmits the Ethernet frame to the integrated ECU 101.

In addition, in a predetermined cycle or in response to a request from the integrated ECU 101, the individual ECU 121 obtains a result of detection of an object near the vehicle 1, from a millimeter-wave sensor mounted in the vehicle 1, and generates relative speed information indicating the relative speed between the vehicle 1 and another vehicle such as an oncoming vehicle, based on the obtained detection result. The individual ECU 121 then stores the generated relative speed information to an Ethernet frame, and transmits the Ethernet frame to the integrated ECU 101.

An individual ECU 111 obtains a result of detection of an object near the vehicle 1, from a radar mounted in the vehicle 1. As an example, the individual ECU 111A obtains a result of object detection in a region on the left side in front of the vehicle 1, from a radar R1 mounted in a front left portion of the vehicle 1, the individual ECU 111B obtains a result of object detection in a region on the left side behind the vehicle 1, from a radar R2 mounted in a rear left portion of the vehicle 1, the individual ECU 111C obtains a result of object detection in a region on the right side in front of the vehicle 1, from a radar R3 mounted in a front right portion of the vehicle 1, and the individual ECU 111D obtains a result of object detection in a region on the right side behind the vehicle 1, from a radar R4 mounted in a rear right portion of the vehicle 1.

When a change in the external environment surrounding the vehicle 1 is detected, an individual ECU 111 transmits an event message to the integrated ECU 101.

More specifically, the individual ECU 111 calculates a distance D between the vehicle 1 and an object near the vehicle 1 based on a detection result obtained from a corresponding radar, for example, at a calculation timing TD that is based on a predetermined calculation cycle CD, and records the distance D to a storage unit. Upon calculating the distance D at the calculation timing TD, for example, the individual ECU 111 calculates a temporal change in the distance D based on the distance D and a distance D calculated in the past and stored in the storage unit, and, if the calculated temporal change is larger than or equal to a predetermined value, the individual ECU 111 generates an event message that includes distance information indicating the most recently calculated distance D, and transmits the event message to the integrated ECU 101. On the other hand, if the calculated temporal change is smaller than the predetermined value, the individual ECU 111 stores the calculated distance D to the storage unit and waits for a new calculation timing TD, without transmitting an event message.

The event message is, for example, a message that complies with SOME/IP (Scalable service-Oriented MiddlewarE over IP) that is a protocol of an application layer of the Ethernet protocol group. More specifically, an individual ECU 111 generates an event message that includes distance information in compliance with SOME/IP (Scalable service-Oriented MiddlewarE over IP), stores the generated event message to at least one Ethernet frame, and transmits the Ethernet frame to the integrated ECU 101.

Upon receiving the Ethernet frame from the individual ECU 111, the integrated ECU 101 obtains the distance information from the event message included in the received Ethernet frame, and processes the obtained distance information. The integrated ECU 101 performs driving assistance such as traffic lane departure warning to the driver, based on the obtained distance information, for example. In addition, for example, the integrated ECU 101 performs processing for transferring the obtained distance information to an automated driving ECU (not shown). The automated driving ECU performs automated driving control based on the distance information received from the integrated ECU 101.

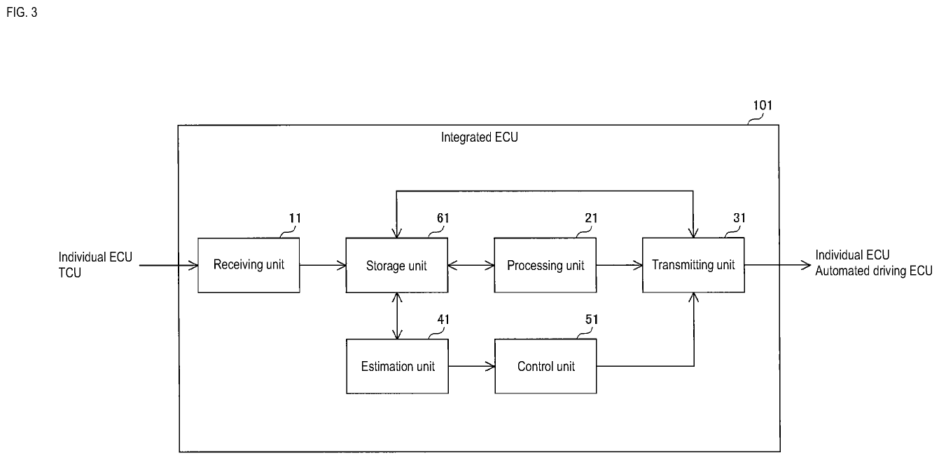

FIG. 3 is a diagram showing a configuration of an integrated ECU according to an embodiment of the present disclosure. As shown in FIG. 3, the integrated ECU 101 includes a receiving unit 11, a processing unit 21, a transmitting unit 31, an estimation unit 41, a control unit 51, and a storage unit 61. The receiving unit 11, the processing unit 21, the transmitting unit 31, the estimation unit 41, and the control unit 51 are each realized by a processor such as a CPU (Central Processing Unit) or a DSP (Digital Signal Processor). The storage unit 61 is a non-volatile memory, for example.

The storage unit 61 stores map information. The map information is stored in the storage unit 61 by the manufacturer of the vehicle 1 at the time of shipment of the vehicle 1, for example. The map information in the storage unit 61 is periodically or non-periodically updated by the user of the vehicle 1, for example.

Upon receiving, from an individual ECU 111, an Ethernet frame that includes an event message, the receiving unit 11 obtains distance information from the event message, and stores the distance information to the storage unit 61.

In addition, the receiving unit 11 receives an Ethernet frame from the TCU 131, obtains traffic congestion information from the received Ethernet frame, and stores the traffic congestion information to the storage unit 61. In addition, the receiving unit 11 receives an Ethernet frame from the TCU 131, obtains update data from the received Ethernet frame, and stores the update data to the storage unit 61. As an example, the receiving unit 11 obtains update data for updating software of the individual ECUs 111, from an Ethernet frame received from the TCU 131, and stores the update data to the storage unit 61.

In addition, the receiving unit 11 receives an Ethernet frame from the individual ECU 121, obtains position information, speed information, or relative speed information, from the received Ethernet frame, and stores the obtained information to the storage unit 61.

The processing unit 21 performs driving assistance such as traffic lane departure warning to the driver based on the distance information stored in the storage unit 61 by the receiving unit 11, for example. Specifically, the processing unit 21 performs processing for displaying a traffic lane departure warning on a display device (not shown), based on the distance information. In addition, for example, the processing unit 21 periodically or non-periodically obtains the distance information from the storage unit 61, and outputs the obtained distance information to the transmitting unit 31.

The transmitting unit 31 stores the distance information received from the processing unit 21, to an Ethernet frame, and transmits the Ethernet frame to the automated driving ECU (not shown).

In addition, the transmitting unit 31 obtains update data from the storage unit 61, and stores the obtained update data to an Ethernet frame, and transmits the Ethernet frame to an individual ECU 111 that is an apparatus to be updated. More specifically, upon receiving later-described control information from the control unit 51, the transmitting unit 31 transmits the update data to the individual ECU 111 at a transmission timing that is based on the received control information.

The estimation unit 41 performs estimation processing for estimating an occurrence frequency of an event message that is transmitted in the on-board network. The estimation unit 41 waits until update data is stored to the storage unit 61 and starts estimation processing when update data is stored to the storage unit 61 by the receiving unit 11, for example. The estimation unit 41 notifies the control unit 51 of an estimation result obtained through estimation processing.

The control unit 51 controls transmission of update data to the individual ECU 111 based on the result of estimation performed by the estimation unit 41. More specifically, the control unit 51 generates control information based on the estimation result notified by the estimation unit 41, and outputs the generated control information to the transmitting unit 31, thereby controlling transmission of update data to the individual ECU 111 that is performed by the transmitting unit 31.

The estimation unit 41 repeats estimation processing until the transmitting unit 31 completes transmission of update data to the individual ECU 111, and ends estimation processing when the transmitting unit 31 completes transmission of update data to the individual ECU 111, and then waits until new update data is stored in the storage unit 61.

### Example 1 of Update Data Transmission

The estimation unit 41 performs estimation processing based on the current position of the vehicle 1 and the map information. More specifically, the estimation unit 41 estimates a period during which the frequency with which the individual ECU 111 transmits an event message is lower than a predetermined value, based on the current position of the vehicle 1 and the map information, which are information obtained from the outside of the vehicle 1. The control unit 51 then controls transmission of update data based on the result of the estimation performed by the estimation unit 41.

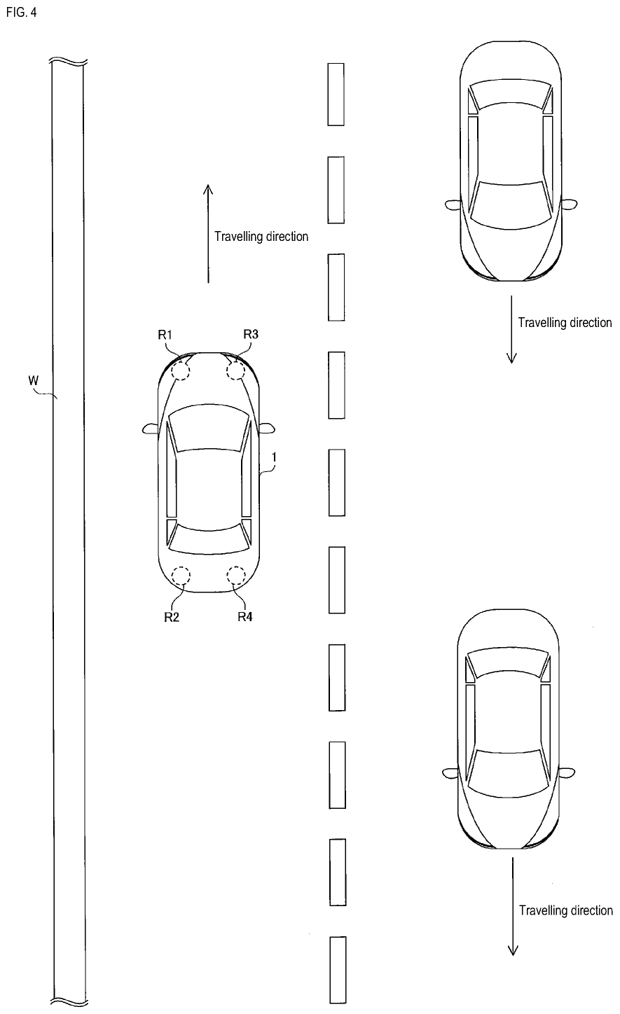

FIG. 4 is a plan view showing an example of a travelling state of a vehicle according to an embodiment of the present disclosure. As shown in FIG. 4, during a period in which the vehicle 1 is running through a tunnel, a wall W that is a portion of the tunnel is present on the left side in the travelling direction of the vehicle 1.

In this case, the distance D that is calculated by the individual ECU 111A based on a detection result obtained from the radar R1 and the distance D calculated by the individual ECU 111B based on a detection result obtained from the radar R2 each indicate the distance between the vehicle 1 and the wall W. In addition, temporal changes in the distances D calculated by the individual ECUs 111A and 111B are relatively small when the vehicle 1 continues to travel on the same traffic lane in the tunnel. Therefore, the frequency with which the individual ECUs 111A and 111B generate an event message that includes distance information and transmit the event message to the integrated ECU 101 is relatively low during a period in which the vehicle 1 is travelling through the tunnel.

On the other hand, the distance D calculated by the individual ECU 111C based on a detection result obtained from the radar R3 and the distance D calculated by the individual ECU 111D based on a detection result obtained from the radar R4 each indicate the distance between the vehicle 1 and an oncoming vehicle. In addition, when there are at least a certain number of oncoming vehicles, temporal changes in the distances D calculated by the individual ECUs 111C and 111D are larger than the temporal changes in the distances D calculated by the individual ECUs 111A and 111B. Therefore, the frequency with which the individual ECUs 111C and 111D generate an event message that includes distance information and transmit the event message to the integrated ECU 101 is relatively high.

The estimation unit 41 obtains the map information and the position information from the storage unit 61, and estimates a tunnel travelling period that is a period during which the vehicle 1 travels through a tunnel, based on the obtained map information and position information. The estimation unit 41 then notifies the control unit 51 of the estimation result indicating that frequency with which the individual ECUs 111A and 111B transmit an event message during the estimated tunnel travelling period is lower than a predetermined value.

Upon receiving the estimation result, the control unit 51 outputs, to the transmitting unit 31, control information indicating that transmission of update data to the individual ECUs 111A and 111B is to be performed during the tunnel travelling period indicated by the estimation result, for example.

Upon receiving the control information from the control unit 51, the transmitting unit 31 obtains the update data from the storage unit 61 based on the received control information, stores the obtained update data to an Ethernet frame, and transmits the Ethernet frame to the individual ECUs 111A and 111B. More specifically, the transmitting unit 31 starts transmission of the update data to the individual ECUs 111A and 111B when the tunnel travelling period starts, and stops transmission of the update data to the individual ECUs 111A and 111B when the tunnel travelling period ends.

Note that the estimation unit 41 is configured to estimate a tunnel travelling period based on map information and position information, and notify the control unit 51 of an estimation result indicating that a frequency with which the individual ECUs 111A and 111B transmit an event message during the estimated tunnel travelling period is lower than a predetermined value, but there is no limitation thereto. A configuration may also be adopted in which, if it is determined, based on map information and position information, that the current position of the vehicle 1 is in a tunnel, the estimation unit 41 estimates that the current frequency with which the individual ECUs 111A and 111B transmit an event message is lower than a predetermined value, and notifies the control unit 51 of the estimation result.

### Example 2 of Update Data Transmission

The estimation unit 41 performs estimation processing based further on traffic congestion information in addition to the current position of the vehicle 1 and the map information. More specifically, the estimation unit 41 estimates a period during which the frequency with which an individual ECU 111 transmits an event message is lower than a predetermined value, based on the current position of the vehicle 1, the map information, and the traffic congestion information, which are information obtained from the outside of the vehicle 1. The control unit 51 then controls transmission of update data based on the result of estimation performed by the estimation unit 41.

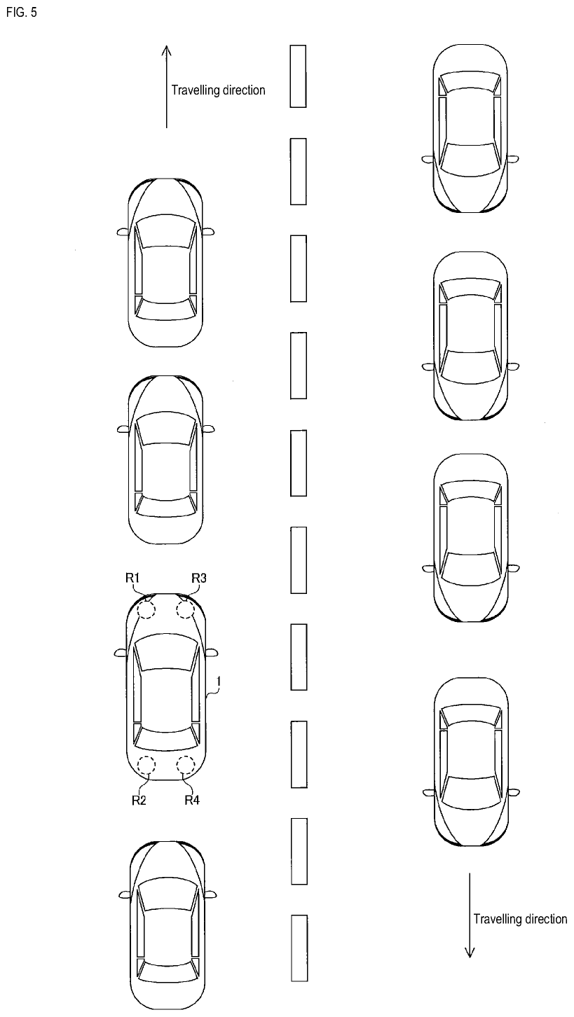

FIG. 5 is a plan view showing another example of a travelling state of a vehicle according to an embodiment of the present disclosure. As shown in FIG. 5, the traffic lane on which the vehicle 1 is travelling and the opposite lane are congested, and the vehicle 1 is travelling at a low speed of 5 km/h or lower, for example.

In this case, the distance D calculated by the individual ECU 111A based on a detection result obtained from the radar R1 indicates the distance between the vehicle 1 and a vehicle travelling ahead of the vehicle 1. In addition, the distance D calculated by the individual ECU 111B based on a detection result obtained from the radar R2 indicates the distance between the vehicle 1 and a vehicle travelling behind the vehicle 1. In addition, the distance D calculated by the individual ECU 111C based on a detection result obtained from the radar R3 indicates the distance between the vehicle 1 and a vehicle travelling ahead of the vehicle 1, or the distance between the vehicle 1 and an oncoming vehicle. In addition, the distance D calculated by the individual ECU 111D based on a detection result obtained from the radar R4 indicates the distance between the vehicle 1 and a vehicle travelling behind the vehicle 1, or the distance between the vehicle 1 and an oncoming vehicle.

In addition, temporal changes in the distances D calculated by the individual ECUs 111A, 111B, 111C, and 111D are relatively small when the traffic lane on which the vehicle 1 is travelling and the opposite lane are congested. Therefore, the frequency with which the individual ECUs 111A, 111B, 111C, and 111D generate an event message that includes distance information and transmit the event message to the integrated ECU 101 is relatively low during a period in which the vehicle 1 is travelling in a congested area.

The estimation unit 41 obtains the map information, the position information, and the traffic congestion information from the storage unit 61, and estimates a traffic congestion travelling period that is a period during which the vehicle 1 is travelling in a congested area, based on the obtained map information, position information, and traffic congestion information. The estimation unit 41 then notifies the control unit 51 of the estimation result indicating that frequency with which the individual ECUs 111A, 111B, 111C, and 111D transmit an event message during the estimated traffic congestion travelling period is lower than a predetermined value.

Upon receiving the estimation result, the control unit 51 outputs, to the transmitting unit 31, control information indicating that transmission of update data to the individual ECUs 111A, 111B, 111C, and 111D is to be performed during the traffic congestion travelling period indicated by the estimation result, for example.

Upon receiving the control information from the control unit 51, the transmitting unit 31 obtains the update data from the storage unit 61 based on the received control information, stores the obtained update data to an Ethernet frame, and transmits the Ethernet frame to the individual ECUs 111A, 111B, 111C, and 111D. More specifically, the transmitting unit 31 starts transmission of the update data to the individual ECUs 111A, 111B, 111C, and 111D when the traffic congestion travelling period starts, and stops transmission of the update data to the individual ECUs 111A, 111B, 111C, and 111D when the traffic congestion travelling period ends.

Note that the estimation unit 41 is configured to estimate a traffic congestion travelling period based on map information, position information, and traffic congestion information, and notify the control unit 51 of the estimation result indicating that the frequency with which the individual ECUs 111A, 111B, 111C, and 111D transmit an event message during the estimated traffic congestion travelling period is lower than a predetermined value, but there is no limitation thereto. A configuration may also be adopted in which, if it is determined, based on map information, position information, and traffic congestion information, that the current position of the vehicle 1 is in a congested area, the estimation unit 41 estimates that the current frequency with which the individual ECUs 111A, 111B, 111C, and 111D transmit an event message is lower than a predetermined value, and notifies the control unit 51 of the estimation result.

### Example 3 of Update Data Transmission

The estimation unit 41 performs estimation processing based on a change amount of the travelling speed of the vehicle 1. More specifically, the estimation unit 41 estimates the current frequency with which an individual ECU 111 transmits an event message, based on a change amount of the travelling speed that is a measurement result of the vehicle 1. The control unit 51 then controls transmission of update data, based on the result of estimation performed by the estimation unit 41.

More specifically, for example, as a result of the vehicle 1 slowing down in accordance with a driver's operation, a temporal change in the distance D between the vehicle 1 and an object such as a stationary object near the vehicle 1 decreases. In addition, for example, as a result of the vehicle 1 slowing down in accordance with a driver's operation due to the vehicle 1 entering a congested area, a temporal change in the distance D between the vehicle 1 and each of the vehicles ahead of and behind the vehicle 1 and an oncoming vehicle decreases.

Therefore, the frequency with which the individual ECUs 111A, 111B, 111C, and 111D generate an event message that includes distance information and transmit the event message to the integrated ECU 101 decreases when the vehicle 1 slows down.

The estimation unit 41 calculates a change amount of the travelling speed of the vehicle 1 based on speed information stored in the storage unit 61, at a calculation timing TV that is based on a predetermined calculation cycle CV, for example. If the decrease amount of the travelling speed of the vehicle 1 per unit time is larger than or equal to a predetermined value, the estimation unit 41 estimates that the current frequency with which the individual ECUs 111A, 111B, 111C, and 111D transmit an event message is lower than a predetermined value, and notifies the control unit 51 of the estimation result.

Upon receiving the estimation result, the control unit 51 outputs, to the transmitting unit 31, control information indicating that transmission of update data to the individual ECUs 111A, 111B, 111C, and 111D is to be started, for example.

Upon receiving the control information from the control unit 51, the transmitting unit 31 starts transmission of update data to the individual ECUs 111A, 111B, 111C, and 111D based on the received control information.

Thereafter, for example, if the increase amount of the travelling speed of the vehicle 1 per unit time calculated at a calculation timing TV is larger than or equal to a predetermined value, the estimation unit 41 estimates that the current frequency with which the individual ECUs 111A, 111B, 111C, and 111D transmit an event message is higher than or equal to the predetermined value, and notifies the control unit 51 of the estimation result.

Upon receiving the estimation result, the control unit 51 outputs, to the transmitting unit 31, control information indicating that transmission of update data to the individual ECUs 111A, 111B, 111C, and 111D is to be stopped, for example.

Upon receiving the control information from the control unit 51, the transmitting unit 31 stops transmission of update data to the individual ECUs 111A, 111B, 111C, and 111D based on the received control information.

### Example 4 of Update Data Transmission

The estimation unit 41 performs estimation processing based on the travelling speed of the vehicle 1 and the relative speed between the vehicle 1 and another vehicle. More specifically, the estimation unit 41 estimates the current frequency with which an individual ECU 111 transmits an event message, based on the travelling speed and the relative speed, which are measurement results of the vehicle 1. The control unit 51 then controls transmission of update data based on the result of estimation performed by the estimation unit 41.

More specifically, for example, when the traffic lane on which the vehicle 1 is travelling is congested while the opposite lane is not congested and a vehicle on the opposite lane is travelling at a high speed, the temporal change in the distance D between the vehicle 1 and each of the vehicles ahead of and behind the vehicle 1 is small while the temporal change in the distance D between the vehicle 1 and an oncoming vehicle is large.

Therefore, the frequency with which the individual ECUs 111A and 111B generate an event message that includes distance information and transmit the event message to the integrated ECU 101 is relatively low when the travelling speed of the vehicle 1 is low and the travelling speed of the oncoming vehicle is high. On the other hand, the frequency with which the individual ECUs 111C and 111D generate an event message that includes distance information and transmit the event message to the integrated ECU 101 is relatively high when the travelling speed of the vehicle 1 is low and the travelling speed of the oncoming vehicle is high.

The estimation unit 41 obtains speed information and relative speed information from the storage unit 61, and, if the travelling speed of the vehicle 1 indicated by the obtained speed information is lower than a predetermined value and the relative speed indicated by the obtained relative speed information is higher than or equal to a predetermined value, the estimation unit 41 estimates that the current frequency with which the individual ECUs 111A and 111B transmit an event message is lower than a predetermined value and the current frequency with which the individual ECUs 111C and 111D transmit an event message is higher than or equal to the predetermined value, and notifies the control unit 51 of the estimation result.

Upon receiving the estimation result, the control unit 51 outputs, to the transmitting unit 31, control information indicating that transmission of update data to the individual ECUs 111A and 111B is to be started, for example.

Upon receiving the control information from the control unit 51, the transmitting unit 31 starts transmission of update data to the individual ECUs 111A and 111B based on the received control information.

Thereafter, for example, when the travelling speed of the vehicle 1 indicated by the speed information obtained from the storage unit 61 is higher than or equal to a predetermined value, the estimation unit 41 estimates that the current frequency with which the individual ECUs 111A and 111B transmit an event message is higher than or equal to the predetermined value, and notifies the control unit 51 of the estimation result.

Upon receiving the estimation result, the control unit 51 outputs, to the transmitting unit 31, control information indicating that transmission of update data to the individual ECUs 111A and 111B is to be stopped, for example. Upon receiving the control information from the control unit 51, the transmitting unit 31 stops transmission of update data to the individual ECUs 111A and 111B based on the received control information.

The above examples 1 to 4 of update data transmission are exemplary. A configuration may also be adopted in which the integrated ECU 101 does not perform at least one of the examples 1 to 4 of update data transmission. In addition, a configuration may also be adopted in which, for example, the estimation unit 41 of the integrated ECU 101 performs estimation processing based on time information in place of some or all of map information, position information, traffic congestion information, speed information, and relative speed information, or in addition to these five types of information.

### Operation Flow

Each apparatus in the on-board communication system according to an embodiment of the present disclosure includes a computer that includes a memory, and a computation processing unit in the computer such as a CPU reads out, from the memory, a program that includes some or all of the steps of the following sequence, and executes the program. The programs of the plurality of apparatuses can be installed from outside. The programs of the apparatuses are distributed in a state of being stored in a recording medium, or through a communication line.

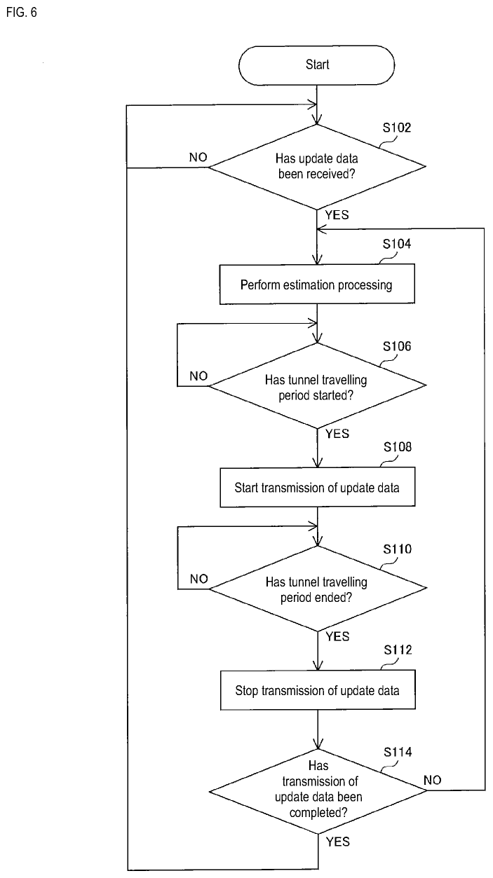

FIG. 6 is a flowchart that defines an example of an operation procedure when an integrated ECU according to an embodiment of the present disclosure transmits update data. FIG. 6 shows a flowchart corresponding to the above example 1 of update data transmission.

As shown in FIG. 6, the integrated ECU 101 first waits for update data from the update server 181 (No in step S102), and performs estimation processing upon receiving update data from the update server 181 via the TCU 131 (YES in step S102). As an example, the integrated ECU 101 estimates a tunnel travelling period based on map information and position information, and estimates the frequency with which the individual ECUs 111A and 111B transmit an event message during the estimated tunnel travelling period is lower than a predetermined value (step S104).

Next, the integrated ECU 101 waits for the start time of the estimated tunnel travelling period (NO in step S106), and, when the start time of the estimated tunnel travelling period comes (YES in step S106), the integrated ECU 101 starts transmission of update data to the individual ECUs 111A and 111B (step S108).

Next, the integrated ECU 101 continues transmission of update data to the individual ECUs 111A and 111B until the end time of the estimated tunnel travelling period comes (NO in step S110), and, when the end time of the estimated tunnel travelling period comes (YES in step S110), the integrated ECU 101 stops transmission of update data to the individual ECUs 111A and 111B (step S112).

Next, if transmission of update data to the individual ECUs 111A and 111B has not been completed (NO in step S114), the integrated ECU 101 performs estimation processing again (step S104).

On the other hand, if transmission of update data to the individual ECUs 111A and 111B has been completed (YES in step S114), the integrated ECU 101 waits for new update data from the update server 181 (NO in step S102).

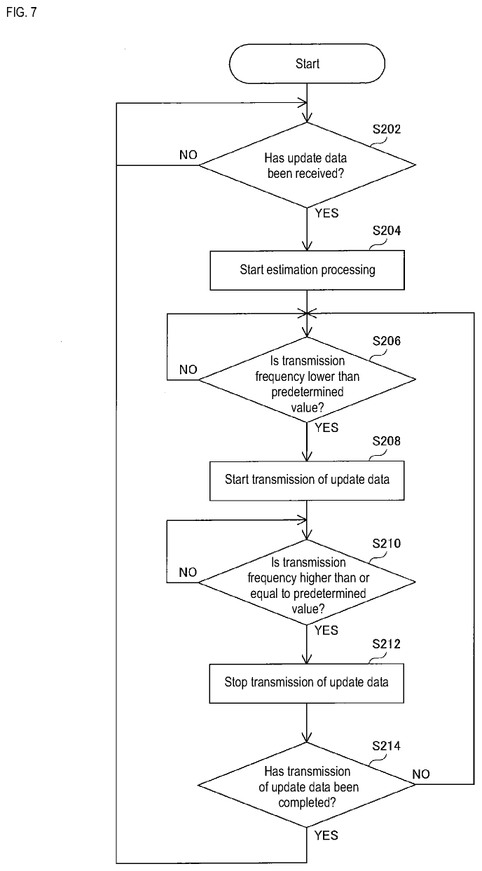

FIG. 7 is a flowchart that defines another example of an operation procedure when an integrated ECU according to an embodiment of the present disclosure transmits update data. FIG. 7 shows a flowchart corresponding to the above example 3 of update data transmission.

As shown in FIG. 7, the integrated ECU 101 first waits for update data from the update server 181 (NO in step S202), and, upon receiving update data from the update server 181 via the TCU 131 (YES in step S202), the integrated ECU 101 starts estimation processing. As an example, the integrated ECU 101 estimates the current frequency with which the individual ECUs 111A, 111B, 111C, and 111D transmit an event message (step S204).

Next, the integrated ECU 101 waits until the current frequency with which the individual ECUs 111A, 111B, 111C, and 111D transmit an event message decreases below a predetermined value (NO in step S206), and, if it is estimated that the current frequency with which the individual ECUs 111A, 111B, 111C, and 111D transmit an event message is lower than the predetermined value, the integrated ECU 101 starts transmission of the update data to the individual ECUs 111A, 111B, 111C, and 111D (step S208).

Next, the integrated ECU 101 continues transmission of the update data to the individual ECUs 111A, 111B, 111C, and 111D until the current frequency with which the individual ECUs 111A, 111B, 111C, and 111D transmit an event message increases to the predetermined value or higher (NO in step S210), and, if it is estimated that the current frequency with which the individual ECUs 111A, 111B, 111C, and 111D transmit an event message is higher than or equal to the predetermined value (YES in step S210), the integrated ECU 101 stops transmission of the update data to the individual ECUs 111A, 111B, 111C, and 111D (step S212).

Next, if transmission of the update data to the individual ECUs 111A, 111B, 111C, and 111D has not been completed (NO in step S214), the integrated ECU 101 waits until the current frequency with which the individual ECUs 111A, 111B, 111C, and 111D transmit an event message decreases below the predetermined value again (No in step S206).

On the other hand, if transmission of the update data to the individual ECUs 111A, 111B, 111C, and 111D has been completed (YES in step S214), the integrated ECU 101 ends estimation processing, and waits for new update data from the update server 181 (NO in step S202).

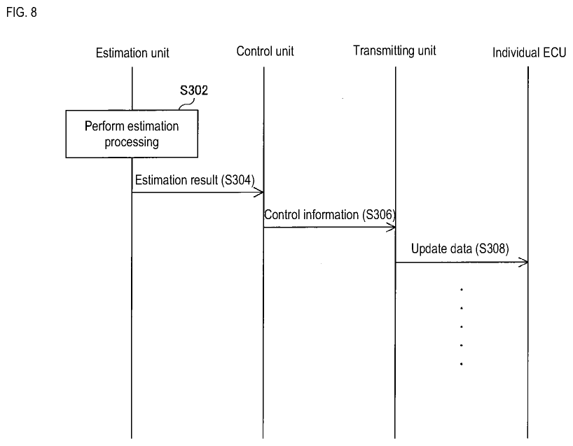

FIG. 8 is a diagram showing an example of a sequence of data transmission that is performed in an on-board communication system according to an embodiment of the present disclosure.

As shown in FIG. 8, the estimation unit 41 first performs estimation processing. The estimation unit 41 performs estimation processing based on map information and position information, for example. Alternatively, the estimation unit 41 performs estimation processing based on map information, position information, and traffic congestion information. Alternatively, the estimation unit 41 performs estimation processing based on speed information. Alternatively, the estimation unit 41 performs estimation processing based on speed information and relative speed information (step S302).

Next, the estimation unit 41 notifies the control unit 51 of the estimation result (step S304).

Next, the control unit 51 controls transmission of update data to an individual ECU 111 based on the result of estimation performed by the estimation unit 41. More specifically, the control unit 51 generates control information based on the estimation result notified by the estimation unit 41, and outputs the generated control information to the transmitting unit 31 (step S306).

Next, the transmitting unit 31 transmits update data to an individual ECU 111 at a transmission timing that is based on the control information received from the control unit 51 (step S308).

Note that the integrated ECU 101 in the on-board communication system 301 according to an embodiment of the present disclosure is configured to receive update data for updating the software of an individual ECU 111, from the update server 181 via the TCU 131, and transmit the received update data to the individual ECU 111, but there is no limitation thereto. The integrated ECU 101 may also be configured to receive update data for updating software of an apparatus other than the individual ECUs 111 in the on-board network, and transmit the received update data to the apparatus.

In addition, each individual ECU 111 in the on-board communication system 301 according to an embodiment of the present disclosure is configured to transmit an event message that complies with SOME/IP to the integrated ECU 101, but there is no limitation thereto. The individual ECU 111 may also be configured to transmit an event message that complies with CAN (Controller Area Network, registered trademark), for example, to the integrated ECU 101. In this case, the individual ECU 111 is connected to the integrated ECU 101 via a CAN bus in place of the cable 2.

In addition, the control unit 51 of the integrated ECU 101 according to an embodiment of the present disclosure is configured to control start and stop of transmission of update data, as control of transmission of update data to an individual ECU 111 that is performed by the transmitting unit 31, but there is no limitation thereto. The control unit 51 may also be configured to control the transmission rate of update data, as control of transmission of update data to the individual ECU 111 that is performed by the transmitting unit 31.

A configuration is adopted in which the estimation unit 41 and the control unit 51 in the on-board communication system 301 according to the embodiment of the present disclosure are provided in the integrated ECU 101, but there is no limitation thereto. A configuration may also be adopted in which the estimation unit 41 and the control unit 51 are provided in an apparatus other than the integrated ECU 101 such as a switch apparatus. In addition, a configuration may also be adopted in which the estimation unit 41 and the control unit 51 are provided in different apparatuses.

The above embodiments are examples in all respects and should not be interpreted as limiting in any manner. The scope of the present disclosure is defined not by the foregoing meanings, but is defined by the claims and intended to include all modifications within the meaning and scope equivalent to the claims.

The foregoing description includes characteristics to be added as below.

An on-board apparatus including an estimation unit configured to estimate an occurrence frequency of an event message that is transmitted in an on-board network, and a control unit configured to control transmission of update data to an apparatus targeted for update in the on-board network, based on a result of estimation performed by the estimation unit, the estimation unit estimating a period in which the occurrence frequency is lower than a predetermined value, based on the current position of a vehicle and map information, and the control unit controlling transmission of the update data based on a result of estimation performed by the estimation unit.

1. An on-board apparatus that is mounted in a vehicle, comprising:
an estimation unit configured to estimate an occurrence frequency of an event message that is transmitted in an on-board network; and
a control unit configured to control transmission of update data to an apparatus targeted for update in the on-board network, based on a result of estimation performed by the estimation unit,
wherein a plurality of on-board apparatuses that each obtain a result of detection of an object near the vehicle from a corresponding radar among a plurality of radars provided at different positions in the vehicle, and transmit an event message based on the obtained result of detection are provided in the on-board network,
the estimation unit estimates the occurrence frequency for each of the on-board apparatuses, and
the control unit controls, based on the result of estimation for each on-board apparatus performed by the estimation unit, transmission of the update data to the on-board apparatus corresponding to the estimation result.

2. The on-board apparatus according to claim 1,
wherein the estimation unit estimates the occurrence frequency for each of the on-board apparatuses based on map information and a current position of the vehicle.

3. The on-board apparatus according to claim 2,
wherein the estimation unit estimates the occurrence frequency based further on traffic congestion information.

4. The on-board apparatus according to claim 1,
wherein the estimation unit estimates the occurrence frequency based on a change amount of a travelling speed of the vehicle.

5. The on-board apparatus according to claim 1,
wherein the estimation unit estimates the occurrence frequency for each of the on-board apparatuses based on a travelling speed of the vehicle and a relative speed between the vehicle and another vehicle.

6. The on-board apparatus according to claim 1, wherein the event message is a message that complies with SOME/IP (Scalable service-Oriented MiddlewarE over IP).

7. The on-board apparatus according to claim 2,
wherein, if the vehicle is positioned in a tunnel, the estimation unit estimates that an occurrence frequency regarding an on-board apparatus corresponding to a radar positioned on a side of a wall of the tunnel is lower than an occurrence frequency regarding an on-board apparatus corresponding to a radar positioned at another location, and
the control unit controls transmission of the update data to the on-board apparatus corresponding to the radar positioned on the side of the wall of the tunnel, based on a result of estimation performed by the estimation unit.

8. The on-board apparatus according to claim 5,
wherein, if a traveling speed of the vehicle is lower than a predetermined value and a relative speed between the vehicle and another vehicle is higher than or equal to a predetermined value, the estimation unit estimates that an occurrence frequency regarding an on-board apparatus corresponding to a radar positioned on an opposite side of an oncoming lane is lower than an occurrence frequency regarding an on-board apparatus corresponding to a radar positioned on a side of the oncoming lane, and
the control unit controls transmission of the update data to the on-board apparatus corresponding to the radar positioned on the opposite side of the oncoming lane, based on a result of estimation performed by the estimation unit.

9. An on-board communication system that is to be mounted in a vehicle, the system comprising:
an estimation unit; and
a control unit,
wherein the estimation unit is configured to estimate an occurrence frequency of an event message that is transmitted in an on-board network, and notify the control unit of an estimation result,
the control unit is configured to control transmission of update data to an apparatus targeted for update in the on-board network, based on the estimation result notified by the estimation unit,
a plurality of on-board apparatuses that each obtain a result of detection of an object near the vehicle from a corresponding radar among a plurality of radars provided at different positions in the vehicle, and transmit an event message based on the obtained result of detection are provided in the on-board network,
the estimation unit estimates the occurrence frequency for each of the on-board apparatuses, and
the control unit controls, based on the result of estimation for each on-board apparatus performed by the estimation unit, transmission of the update data to the on-board apparatus corresponding to the estimation result.

10. A data transmission method that is performed in an on-board communication system that is to be mounted in a vehicle and includes an estimation unit and a control unit, the data transmission method comprising:
a step of the estimation unit estimating an occurrence frequency of an event message that is transmitted in an on-board network, and notifying the control unit of an estimation result; and
a step of the control unit controlling transmission of update data to an apparatus targeted for update in the on-board network, based on the estimation result notified by the estimation unit,
wherein a plurality of on-board apparatuses that each obtain a result of detection of an object near the vehicle from a corresponding radar among a plurality of radars provided at different positions in the vehicle, and transmit an event message based on the obtained result of detection are provided in the on-board network,
in the step of estimation result notification, the estimation unit estimates the occurrence frequency for each of the on-board apparatuses, and
in the step of transmission control, the control unit controls, based on the result of estimation for each on-board apparatus performed by the estimation unit, transmission of the update data to the on-board apparatus corresponding to the estimation result.
